(19) United States
(12) Patent Application Publication
(10) Pub. No.: US 2021/0161194 A1
(43) Pub. Date: Jun. 3, 2021

(54) METHODS AND SYSTEMS FOR MAKING FOOD

(71) Applicant: TROUW NUTRITION USA LLC, Highland, IL (US)

(72) Inventor: Gary GOLDY, Highland, IL (US)

(21) Appl. No.: 16/610,228

(22) PCT Filed: Apr. 30, 2018
(86) PCT No.: PCT/US2018/030243

§ 371 Date: Nov. 1, 2019

(30) Foreign Application Priority Data
May 1, 2017 (NL) N2018815

(51) Int. Cl. A23P 30/20; A23N 17/00

(52) U.S. Cl. CPC A23P 30/20; A23N 17/007; A23N 17/005

(57) ABSTRACT

Described herein are methods and systems for preparing a plurality of compositions on a commercial scale, without interruption.

### BACKGROUND

Extrusion systems have long been used for the production of a variety of food and other products. For example, many pet and human foods are produced using such equipment. Many extrusion systems include a preconditioner and an extruder in series relationship. Dry materials are fed from a bin system into the preconditioner, where the materials are hydrated and partially cooked through application of steam and/or water and intense mixing. Such preconditioning materials are then fed into an extruder equipped with one or more elongated, axially rotatable augers and an end-most apertured extrusion die. In the extruder, the materials are subjected to intense heat, pressure and shear and are forced through the extrusion die for complete cooking and shaping. Thereafter, the extruded products are typically dried and cooled in a drying system such as, for example, a multi-pass dryer or a vertical dryer.

While extrusion systems of this type are common, significant operational problems remain. One such issue is the amount of waste involved in any given production run. Specifically, at the start of a run, waste is generated until the system reaches equilibrium and continuous flow rates, pressures, temperatures, and residence times are established. Even more significant, however, is the waste problem encountered at the end of an extrusion run. Thus, when the last of a quantity of starting material is fed to the preconditioner, there inevitably follows a period where the flow of material to the extruder falls off until the preconditioner is emptied. Normally, the product produced during this last run stage is unacceptable and must be discarded. Given that preconditioners hold from 900-1800 pounds of material, it will be appreciated that the last-stage waste is significant.

Another challenge associated with extrusion processing stems from the down time associated with run changeovers. That is, when a manufacturer needs to change a system to produce a different product, down times of an hour or more are not uncommon. And, if a series of short (e.g., 5-ton or less) runs are scheduled, the changeover problem becomes significant.

The short run phenomenon also presents potential issues for the post-extrusion drying operation. That is, the end-stage extrudate from a first run must not be allowed to commingle with the first-stage product from the next succeeding run. Therefore, unless special steps are taken, the extruder must be shut down between runs to allow sufficient time for passage and clearance of all the extruded product through the dryer.

At the same time, the number of products made in a single factory, using the same equipment, has dramatically increased to meet consumer demand for customized products. This has led to shorter production runs for an expanded number of product offerings within a product line. Short runs result in extensive down time between cycles that produce different products.

As such, there is a need for improved processes and systems which overcome one or more of the problems outlined above and provide efficient changeover capability while minimizing product loss and maximizing the number of compositions that can be produced. Embodiments of the present invention are designed to meet these, and other, needs.

### SUMMARY

Some embodiments of the present invention are directed to methods of making edible compositions for human or animal consumption. More specifically, various aspects of the present invention relate to the use of multiple pre-mixed or pre-blended batches of ingredients, wherein the amount of each ingredient batch can be altered in real-time during a production process to produce different edible compositions without having to stop production machinery for different compositions.

Some embodiments of the present invention provide methods wherein a common dry batch is added to a preconditioner and used as the primary base to produce multiple products within a product line. In some embodiments, the inclusion rate of the primary base varies between products. In other embodiments, a customized base mix is added to a preconditioner and combined with the common base mix to create a unique total dry ratio for each product that is fed into the extruder. In some embodiments, the preconditioner must be capable of mixing the two dry mixes together on a continuous basis with an industry acceptable coefficient of variation (CV). In other embodiments, high moisture meat ingredients, additional fat, steam and/or water may be added to the preconditioner as needed.

In accordance with various aspect of the present disclosure, systems for making multiple edible compositions, each edible composition being a different formulation, in a continuous fashion (i.e., without stopping the system between the making of individual edible compositions) are utilized. Systems according to various aspects of the present disclosure can include a preconditioner, an extruder coupled with the preconditioner, and a plurality of storage bins coupled with the preconditioner. Each storage bin can hold a pre-blended or pre-mixed batch comprising one or more ingredients. For example, one of the plurality of storage bins can hold a dry batch which is common for multiple edible compositions, another one of the plurality of storage bins can hold a customized base mix which is only used in certain edible compositions, and yet another one of the plurality of storage bins can hold a different customized base mix which is used in other edible compositions. The common dry batch can have a single ingredient or more than one ingredient.

In accordance with various aspects of the present disclosure, a predetermined amount of a pre-blended or pre-mixed dry batch and a predetermined amount of one or more pre-blended or pre-mixed customized base mixes are delivered to the preconditioner. In some instances, a predetermined amount of a meat batch and/or liquids, such as, for example, water and/or liquid fat(s), can also be delivered to the preconditioner. The dry batch, one or more customized base mixes, meat batch, and liquids can each be delivered to the preconditioner from a corresponding storage bin. The ratio of components (i.e. dry batch, custom base mixes, meat batch, and liquids) delivered to the preconditioner can be changed incrementally (i.e., gradually changing the amount of one or more components delivered over a period of time) or instantaneously (i.e., immediately changing the amount of one or more components delivered from a first amount to a second, different, amount) to transition between production of different edible compositions having different component ratios. During production of a first composition, one or more of a plurality of regulator or metering systems, each one corresponding to one or more of the plurality of storage bins, can be actuated to change the ratio of components transmitted to the preconditioner. For example, after a predetermined period of time that, or after a predetermined mass percentage of, the first composition has been transmitted from the preconditioner to the extruder, one or more of the regulator or metering systems can be actuated such that the amounts of components delivered to the preconditioner are changed to stop production of first edible composition and initiate production of a second composition. Products progressing through the system which contain a mixture of both the first and second compositions can be discarded either during transmission from the preconditioner to the extruder, or during transmission from the extruder to a drying apparatus, to prevent contamination of the first and second compositions.

In accordance with various aspects of the present disclosure, during the transition from production of a first composition to production of a second composition, the system continues to run. Embodiments of the present invention therefore allow for transition between the production of various edible compositions via control of the relative amounts of materials (that is, common dry batch, one or more custom base mixes, meat batch, liquid(s), or any other components of a given composition) delivered from corresponding storage bins to the preconditioner. The relative amounts of components transmitted to the preconditioner can be controlled manually, by a user, or in an automated fashion by, for example, a PLC controller incrementally (i.e., gradually changing the amount of one or more components transmitted over a period of time) or instantaneously (i.e., immediately changing the amount of one or more components transmitted from a first amount to a second, different, amount). As the system continues run during production of various edible compositions, machinery downtime between production cycles of various products is avoided.

In some embodiments, the present invention enables the efficient production of multiple compositions without interruption. In some embodiments, the methods and systems of the present invention are adapted to continuously produce eight to twelve compositions, each having a different formulation, without interruption. In some embodiments, the present invention allows for on the fly transition from one product to another. Further embodiments provide a base mix that can be used as a platform for preparing a plurality of compositions.

In further embodiments, the present invention provides a consumable composition produced by any one of the methods, systems or processes described herein. In some embodiments, a consumable composition is constructed from a common blend of dry mixed ingredients that are introduced into a preconditioning system in conjunction with the addition of one or more additional dry mixtures that are also added to the preconditioner. Wet meats (greater than 20% moisture content), fats, water and steam may or may not be added into the preconditioner. In some embodiments, both the common dry mix and the additional customized mix are individually added to the preconditioner simultaneously. In some embodiments, the methods, systems and processes of the present invention have the ability to maintain a 5% CV.

### BRIEF DESCRIPTION OF THE DRAWING

The drawing accompanying this disclosure illustrates certain aspects of some embodiments of the present invention and should not be used to limit or define the scope of the present disclosure.

FIG. 1 is a schematic illustration of a system suitable for making edible compositions in accordance with various embodiments of the present disclosure.

### DETAILED DESCRIPTION

The following description of the embodiments are merely exemplary in nature and are in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

For the purposes of this specification and appended claims, the term “coupled” refers to the linking or connection of two objects. The coupling can be permanent or reversible. The coupling can be direct or indirect. An indirect coupling includes connecting two objects through one or more intermediary objects. The term “substantially” refers to an element essentially conforming to the particular dimension, shape or other word that substantially modifies, such that the component need not be exact. For example, substantially circular means that the object resembles a circle, but can have one or more deviations from a true circle.

For the purpose of the specification and appended claims, the terms “animal food,” “pet food,” and “pet food formulation” refers to treats, snacks, specialty food products, dietary supplements, completed and balanced pet foods, complete and balanced treats or snacks, and complete and balanced specialty food products.

For the purposes of this specification and appended claims, the term “product line” refers to a group of related products produced by one manufacturer, for example products that are intended to be used for similar purposes. Often, but not always, such related products are prepared using the same dry batch composition and/or base mix, albeit in different amounts.

The present disclosure can be applied to the production of any food composition that is ingestible by a human or an animal and provides nutritional value to the human or animal. The compositions can be varied while maintaining a nutritionally balanced mixture of proteinaceous and farinaceous ingredients. In some embodiments, the compositions of the present invention have a moisture level of less than about 50% by weight. In some embodiments, the compositions described herein can be baked, extruded, pelleted, or otherwise formed. Such forms of food products, and methods for their production, are well known to those of skill in the art of food manufacturing.

Generally, aside from the nutritional balancing additives included in these products, such as the vitamins and minerals, or the other additives, such as preservatives and emulsifiers and the like, the compositions—for the most part—will consist of ingredients which may be described as substantially proteinaceous or substantially farinaceous.

Although the following should not be considered limiting, a proteinaceous ingredient can generally be defined as any material having a protein content of at least about 15% by weight, whereas a farinaceous material has a protein content substantially below this and has a major fraction of starchy or carbohydrate containing materials.

Examples of proteinaceous materials, which are typically used in commercial animal foods, are vegetable protein meals, such as soybean, cottonseed, peanut, animal proteins such as casein, albumin, and meat tissue including fresh meat as well as rendered or dried “meals” such as fish meal, poultry meal, meat meal, meat and bone meal, enzymatically-treated protein hydrolysates, and the like. Other types of proteinaceous materials include microbial protein such as yeast, and other types of protein, including materials such as wheat gluten or corn gluten.

Examples of typical farinaceous materials include enzymatic farinaceous materials, potato, tapioca, grains such as corn, maize, wheat, sorghum, barley, and various other grains which are relatively low in protein. Numerous other materials could be added to the animal food, especially cat food, which do not necessarily fall into either category, such as dried whey, and other dairy by-products or carbohydrates.

The term “fat” refers to any edible grade fat or lipid, including fats of avian, animal, plant, or manufactured origin, including, but not limited to, crude or refined fats. Typical animal origin fats include, for example, animal tallow, choice white grease, lard, milk-derived fats such as butter oil, and fat typically contained in cheese. Typical fats of vegetable origin include coconut oil, soybean oil, and corn oil. Typical fats of avian origin include fats derived from the tissue of chickens, turkeys, ducks, and geese, for example.

The term “liquid fat” refers to fat that is substantially flowable, i.e., liquid. The fat can be liquid at room temperature or rendered substantially flowable by heating the fat until the desired flowability is achieved. Preferably, the fat is substantially flowable at temperature between about 10° C. to about 90° C.

The term “dry additive” refers to an additive that is solid at about 25° C. and has a moisture content below about 35 wt %. Typical dry additives include, for example, meat solids, dry animal digest, dry palatants, antibiotics, probiotics, probiotic microorganisms, vitamins, minerals, and tartar control agents.

Meat solids refers to meat and meat by-product. Meat is the tissue of an animal, such as the flesh of cattle, swine, sheep, goats, and other mammals. The meat preferably is beef, veal, or pork. Other sources of solids and by-products include tissue derived from bison, venison, wild boar, chicken, turkey, duck, quail, goose, or fish. “By-product” is the non-rendered part of a carcass of a slaughtered animal, including a mammal, bird, or fish. The terms “meat” and “meat by-product” are used herein in the same manner as described in the Definitions of Feed Ingredients published by the Association of American Feed Control Officials, Inc. (AAFCO).

Dry animal digest refers to a dry digest of meat solids (either meat or meat by-product). Typically, a dry animal digest is prepared by subjecting a meat by-product to proteolytic or lipolytic enzyme digestion, as is well known in the art, with reaction conditions preferably controlled to obtain maximum flavor development. The product is typically then reduced to a substantially dry form, i.e., having low moisture content, to form the dry digest.

Dry palatants refer to any dry additives that increase the palatability of food to an animal. As such, palatants typically include meat and cheese flavorings and, therefore, can include meat solids and dry animal digest, but also include other components that can be present as dry additives, such as herbs, flavors, and the like. Examples of dry palatants include Brewer's yeast, which comprises dried pulverized cells of a yeast of the genus Saccharomyces (usually S. cerevisiae), often used in brewing, Torula yeast, and various yeast extracts. It is known to those of skill in the art that a variety of yeasts can be used as palatants.

The dry additives can include any suitable antibiotics, prebiotics, probiotics, and vitamins. Suitable probiotic microorganisms can include yeast such as Saccharomyces, Debaromyces, Candida, Pichia and Torulopsis, molds such as Aspergillus, Rhizopus, Mucor, and Penicillium and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pedicoccus, Micrococcus, Leuconostoc, Weissella, Aerococcus, Oenococcus and Lactobacillus. Specific examples of suitable probiotic microorganisms are: Saccharomyces cerevisiae, Bacillus coagulans, Bacillus licheniformis, Bacillus subtilis, Bifidobacterium bifidum, Bifidobacterium infantis, Bifidobacterium longum, Enterococcus faecium, Enterococcus faecalis, Lactobacillus acidophilus, Lactobacillus alimentarius, Lactobacillus casei subsp. casei, Lactobacillus casei Shirota, Lactobacillus curvatus, Lactobacillus delbruckii sub sp. lactis, Lactobacillus fareciminus, Lactobacillus gasseri, Lactobacillus helveticus, Lactobacillus johnsonii, Lactobacillus reuteri, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophilus, Strepococcus faecalis, Streptococcus thermophilus, Staphylococcus carnosus, and Staphylococcus xylosus. The probiotic microorganisms preferably are in powdered, dried form. Those microorganisms that form spores desirably are in spore form. Preferably, the probiotic microorganisms are encapsulated, for example, in liquid fat, using the method of the present invention, to increase the likelihood of their survival on the animal food until digestion by an animal.

Other dry additives can include, for example, antioxidants, carotenoids, lutein, bioflavonoids, vitamins, minerals, natural or organic fermentation products or extracts, enzymes, microbial growth inhibitors, and compounds which can provide a benefit by decreasing oral malodor.

Dental active agents are any agents that act to inhibit or prevent dental calculus (tartar) and plaque build-up on teeth. Suitable tartar control agents include, but are not limited to, crystal growth inhibitors, such as soluble pyrophosphates, sodium tripolyphosphate, Sodaphos® (sodium hexametaphosphate), sodium acid metaphosphate, soluble diphosphonates, and certain soluble zinc compounds, such as zinc chloride, and sequestrants, such as sodium hexametaphosphate, hydroxycarboxylic acids, including citric acid, fumaric acid, glutaric acid, acetic acid, oxalic acid, and the like, and their alkali salts, such as sodium citrate, potassium citrate, etc., as well as their aminopolycarboxylic acid derivatives, such as, for example, ethylenediaminetetraacetic acid. Other suitable tartar control agents may include microbial growth inhibitors and enzymes, particularly enzymes that can act by inhibiting deposition of calculus or by breaking down formations of calculus within the oral cavity. Cyclodextrins or other odor control or odor modulating compositions can also be used in coating compositions for application in the method of the present invention.

The dry additives can include other components, such as food grade pigments, viscosity modifiers, pH adjusters, and the like, to desirably affect the surface coating composition and/or the composition to which it is applied.

The term “liquid additive” refers to an additive that is substantially liquid at 25° C. or a substance that has a moisture content above about 35 wt. %. Suitable liquid additives include, for example, water, non-aqueous liquids, aqueous and non-aqueous liquid systems (including liquid emulsions), fat-miscible and immiscible liquids, and suspensions or dispersions of solids in liquids. Typical liquid additives include liquid animal digest, oil, water, vitamins, amino acids, proteins, nutrients, oils, flavors, acidulents, food grade dye compositions, and colorants (such as caramel, which also provides flavor). Liquid animal digest is similar to its dry counterpart, discussed above, except that it is fluid or can be made flowable when applied.

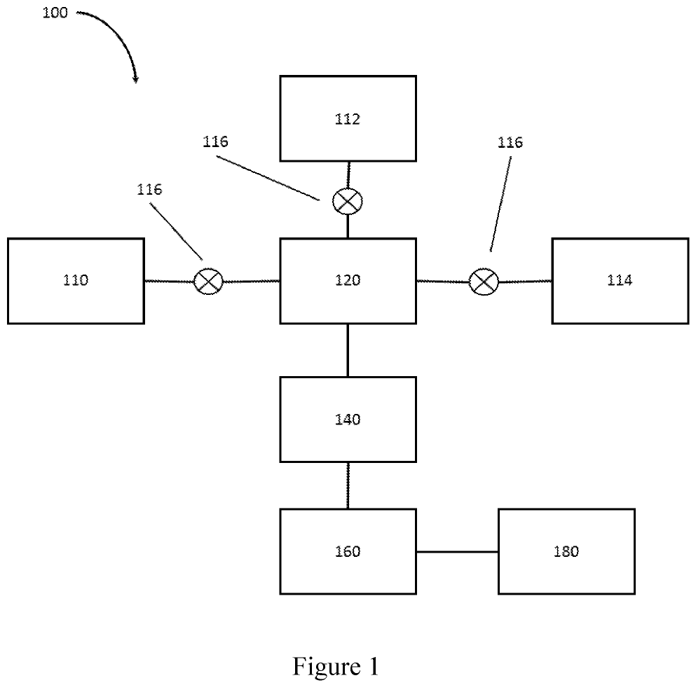

Described herein are methods and systems for making various consumable compositions using predetermined amounts pre-mixed or pre-blended batches of ingredients in a continuous blending and conditioning process. Foods having various ratios of a pre-mixed or pre-blended dry batch (common to all formulations and having one or more ingredients), one or more pre-mixed or pre-blended custom base mixes, and optionally a meat batch and/or liquid(s), can be made using, for example, a multiple purpose quick-changeover extrusion system as described in U.S. Pat. Nos. 6,465,029 and 7,479,294; and PCT Application No. PCT/US01/10004, the entireties of which are hereby incorporated herein by reference. In general however, the methods disclosed herein can be described with reference to FIG. 1.

FIG. 1 is a schematic illustration showing the general components of a system for making consumable compositions having varying formulations. The system 100 includes a preconditioner 120 coupled with an extruder 140. The type of extruder 140 is not particularly limiting. The extruder 140 can be for example, a pellet mill, an extruder, a single- or twin-screw extruder, and co-extruder, a molder, a former, or any similar means known to one of ordinary skill in the art. Each storage bin 110, 112, 114 is coupled with the preconditioner 120 by a corresponding preconditioner inlet valve (not shown). Each preconditioner inlet valve can be actuated manually or in an automated fashion by, for example, a PLC controller, to be in a fully open position, a fully closed position, or any position therebetween. Each storage bin can hold a pre-blended or pre-mixed batch comprising one or more ingredients. For example, the storage bin 110 can hold a dry batch which is common for multiple formulations, storage bin 112 can hold a customized base mix which is only used in certain formulations, and storage bin 114 can hold a different customized base mix which is used in other formulations. The common dry batch can have a single ingredient or more than one ingredient.

While FIG. 1 depicts three storage bins, one of ordinary skill in the art can readily appreciate that more or less storage bins can be coupled with the preconditioner 120 without departing from the scope of the present disclosure. For example, a fourth storage bin (not shown) can be coupled with the preconditioner 120, wherein a meat batch comprising one or more types of animal components can be held. The animal components can be meat solids, fats, liquid fats, etc. Also for example, a fifth storage bin (not shown) can be coupled with the preconditioner 120, wherein one or more liquids such as, for example, liquid fat(s) can be held.

The amount of ingredient batches transmitted from each storage bin 110, 112, 114 to the preconditioner 120 can be controlled by a corresponding regulator or metering system 116 alone or in combination with the corresponding preconditioner inlet valve. The type of regulator or metering system 116 is not particularly limiting. Each regulator or metering system 116, however, should be able to control the amount of pre-blended or pre-mixed ingredient batch delivered from its corresponding storage bin to the preconditioner 120 with accuracy and precision and be able to vary the amount of ingredient batch being delivered to the preconditioner 120 in real-time. Each regulator or metering system 116 can be actuated, for example, by a user manually or in an automated fashion with the assistance of a programmable logic controller (PLC), timing mechanism, or other means of automated actuation.

In the preconditioner 120, the pre-blended or pre-mixed ingredient batches delivered thereto are subjected to intense mixing. During mixing, the ingredient batches can also be hydrated and partially cooked through the application of, for example, steam and/or water. Upon the completion of mixing, hydrating and cooking, a preconditioned composition is formed. The preconditioned composition is then transmitted from the preconditioner 120, through a preconditioner outlet valve (not shown) to the extruder 140 through an extruder inlet valve (not shown). Each of the preconditioner outlet valve and the extruder inlet valve can be actuated manually or in an automated fashion by, for example, a PLC controller, to be in a fully open position, a fully closed position, or any position therebetween.

In the extruder 140, the preconditioned composition is subjected to heat, pressure and shear and is forced through an extrusion die (not shown) for complete cooking and shaping to form an extruded composition. The extruded composition is then transmitted to a drying apparatus 160 to dry and subsequently cool the extruded composition to form the final composition. The final composition is then delivered to a storage bin 180 until packaged or otherwise contained for shipping and/or sale.

In some instances, the extruded composition can be coated, or enrobed, with a mixture containing one or more dry additives, liquid additives, palatants, and/or dental active agents prior to transmission to the drying apparatus 160. In other instances, the final composition can be coated, or enrobed, with a mixture containing one or more dry additives, liquid additives, palatants, and/or dental active agents prior to transmission to the storage bin 180.

As discussed above, a predetermined amount of a pre-blended or pre-mixed dry batch and a predetermined amount of one or more pre-blended or pre-mixed customized base mixes are delivered to the preconditioner 120. Also as discussed above, a predetermined amount of a meat batch and/or liquids, such as, for example, water and/or liquid fat(s), can be delivered to the preconditioner 120. The dry batch, one or more customized base mixes, meat batch, and liquids can each be delivered to the preconditioner 120 from a corresponding storage bin (such as 110, 112, 114). The ratio of components (i.e. dry batch, custom base mixes, meat batch, and liquids) delivered to the preconditioner 120 can be changed incrementally (i.e., gradually changing the amount of one or more components transmitted over a period of time) or instantaneously (i.e., immediately changing the amount of one or more components transmitted from a first amount to a second, different, amount) to transition between production of different compositions having different component ratios. In accordance with various aspects of the present disclosure, the system 100 can initially be configured such that the ratio of the components delivered to the preconditioner 120 is, for example, 59 wt % to 80 wt % dry batch, 3 wt % to 20 wt % meat batch, 4 wt % to 18 wt % customized base mix and 1 to 10 wt % liquids for the production of a first composition. As a more specific example, to prepare a first composition, a ratio of the components delivered to the preconditioner 120 can be for example, 75 wt % dry batch, 15 wt % meat batch, 5 wt % customized base mix and 5 wt % liquids.

As the first composition in the preconditioner 120 nears complete delivery into the extruder 140, one or more of the regulator or metering systems 116 corresponding to one or more of the storage bins 110, 112, 114 can be actuated to change the ratio of components transmitted to the preconditioner 120. For example, after a predetermined period of time that, and/or after a predetermined mass percentage of, the first composition has been transmitted from the preconditioner 120 to the extruder 140, one or more of the regulator or metering systems 116 can be actuated such that 70 wt % dry batch, 18 wt % meat batch, 7 wt % customized base mix and 5 wt % liquids are delivered to the preconditioner 120 for the production of a second composition. In some instances, the system 100 can be configured such that the ratio of the components delivered to the preconditioner 120 for preparation of the second composition fall within the same ranges as initially set up for the first composition (i.e., 59 wt % to 80 wt % dry batch, 3 wt % to 20 wt % meat batch, 4 wt % to 18 wt % customized base mix and 1 to 10 wt % liquids). In other instances, the system 100 can be configured such that the ratio of the components delivered to the preconditioner 120 for preparation of the second composition fall within ranges different than those initially set up for the first composition such as, for example, 50 wt % to 60 wt % dry batch, 6 wt % to 25 wt % meat batch, 8 wt % to 25 wt % customized base mix and 5 to 15 wt % liquids.

Product progressing through the system 100 which contain a mixture of both the first and second compositions can be discarded either during transmission from the preconditioner 120 to the extruder 140 via a first purge valve (not shown) located between the preconditioner 120 and extruder 140, or during transmission from the extruder 140 to the drying apparatus 160 via a second purge valve (not shown) located between the extruder 140 and drying apparatus 160, to prevent contamination of the first and second compositions. Optionally, such mixture can be recycled, sold as a different formulation or donated to animal shelters.

During the transition from production of a first composition to production of a second composition, the system 100 continues to run. Embodiments of the present invention therefore allow for transition between the production of various compositions via control of the relative amounts of components (that is, common dry batch, one or more custom base mixes, meat batch, liquid(s), or any other components of a given composition) delivered from corresponding storage bins (110, 112, 114, etc.) to the preconditioner 120. The relative amounts of components transmitted to the preconditioner 120 can be controlled manually, by a user, or in an automated fashion by, for example, a PLC controller incrementally (i.e., gradually changing the amount of one or more components transmitted over a period of time) or instantaneously (i.e., immediately changing the amount of one or more components transmitted from a first amount to a second, different, amount). As the system 100 continues run during production of various compositions, machinery downtime between production cycles of various products is avoided.

In some instances, the system 100 can further include a mixing system situated between the storage bins 110, 112, 114 and the preconditioner 120 and coupled therewith. When the system 100 includes a mixing system, predetermined amounts of components can be delivered from the storage bins 110, 112, 114 to the mixing system. The components can then be mixed in the mixing system prior to transmission to the preconditioner 120. The type of mixing system is particularly limited. Any mixing system configured to couple with the storage bins 110, 112, 114 and the preconditioner 120, configured to received components from the storage bins 110, 112, 114, and configured to transmit the component mixtures formed therein to the preconditioner 120 can be used. One or more of the regulator or metering systems corresponding to one or more of the storage bins 110, 112, 114 can be actuated to change the ratio of components transmitted to the mixing system. The regulator or metering system can control of the relative amounts of components (that is, common dry batch, one or more custom base mixes, meat batch, liquid(s), or any other components of a given composition) delivered from corresponding storage bins (110, 112, 114, etc.) to the mixing system. The relative amounts of components transmitted to the mixing system can be controlled manually, by a user, or in an automated fashion by, for example, a PLC controller incrementally (i.e., gradually changing the amount of one or more components transmitted over a period of time) or instantaneously (i.e., immediately changing the amount of one or more components transmitted from a first amount to a second, different, amount).

In some embodiments, the present invention enables the efficient production of multiple compositions without interruption. In some embodiments, the methods and systems of the present invention are adapted to continuously produce eight to twelve compositions, each having a different formula, without interruption. In some embodiments, the present invention allows for on the fly transition from one product to another. Further embodiments provide a base mix that can be used as a platform for preparing a plurality of compositions.

Some embodiments of the present invention provide a total annual savings of greater than $250,000, compared to conventional methods. Other embodiments of the present invention provide a total annual savings of greater than $500,000, compared to conventional methods. Still further embodiments of the present invention provide a total annual savings of greater than $750,000, compared to conventional methods.

Yet other embodiments provide increased production capacity. In some embodiments, the increased production capacity is realized over multiple product lines. In other embodiments, the increased production capacity provides an increase in the number of production days.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

1. A continuous method for preparing a plurality of unique compositions, the method comprising:
preparing two or more ingredient batches, the two or more batches comprising a dry batch composition comprising a first set of one or more ingredients and a base mix comprising a second set of one or more ingredients;
delivering a first predetermined amount of each of the two or more ingredient batches to a preconditioning system;
preconditioning the first predetermined amount of each of the two or more ingredient batches in the preconditioning system to form a first preconditioned composition, wherein preconditioning comprises one or more of hydrating, cooking, and mixing;
transmitting the first preconditioned composition to an extruder;
delivering a second predetermined amount of each of the two or more ingredient batches to the preconditioning system;
preconditioning the second predetermined amount of each of the two or more ingredient batches in the preconditioning system to form a second preconditioned composition,
extruding the first preconditioned composition to make a first extruded composition;
transmitting the second preconditioned composition to the extruder; and
extruding the second preconditioned composition to make a second extruded composition.

2. The method of claim 1, further comprising:
preparing a meat batch comprising one or more types of animal components;
delivering a first predetermined amount of meat batch to the preconditioning system to be incorporated into the first preconditioned composition; and
delivering a second predetermined amount of meat batch to the preconditioning system to be incorporated into the second preconditioned composition.

3. (canceled).

4. The method of claim 1, further comprising:
enrobing the extruded compositions with an additive composition.

5-7. (canceled)

8. The method of claim 1, wherein delivery of a predetermined amount of at least one of the two or more ingredient batches to the preconditioning system is controlled by a regulator.

9. The method of claim 1, wherein each of the two or more ingredient batches is stored in a corresponding storage bin, each storage bin coupled with the preconditioning system.

10. (canceled).

11. The method of claim 8, wherein the delivery of a predetermined amount of at least one of the two or more ingredient batches from a corresponding storage bin to the preconditioning system is changed instantaneously or incrementally over time.

12. (canceled).

13. The method of claim 11, wherein the incremental or instantaneous change is initiated by a manual input or an automated input.

14-18. (canceled).

19. The method of claim 1, wherein the preconditioning system is continuously operating between delivery of the first mixture and delivery of the second mixture and the extrusion system is continuously operating between delivery of the first preconditioned composition and delivery of the second preconditioned composition.

20. A method of making multiple unique compositions without interruption, the method comprising:
mixing, in a mixing system, predetermined amounts of two or more pre-made ingredient batches to form a first mixture;
delivering the first mixture to a preconditioning system;
mixing, in the mixing system, predetermined amounts of the two or more pre-made ingredient batches to form a second mixture different from the first mixture;
preconditioning the first mixture in the preconditioning system to form a first preconditioned composition;
transmitting the first preconditioned composition to an extruder;
delivering the second mixture to the preconditioning system;
preconditioning the second mixture in the preconditioning system to form a second preconditioned composition;
extruding the first preconditioned composition to make a first composition;
transmitting the second preconditioned composition to the extruder; and
extruding the second preconditioned composition, in the extrusion system, to make a second composition;
wherein each of the two or more pre-made ingredient batches are stored in separate storage units and delivered to the mixing system in pre-determined amounts.

21. (canceled).

22. The method of claim 20, wherein preconditioning comprises one or more of hydrating, cooking, and mixing.

23-24. (canceled).

25. The method of claim 20, further comprising:
enrobing the extruded compositions with an additive composition.

26-32. (canceled).

33. The method of claim 20, wherein delivery of a predetermined amount of at least one of the two or more ingredient batches from a corresponding storage unit to the mixing system is controlled by a regulator.

34. The method of claim 20, wherein the delivery of a predetermined amount of at least one of the two or more ingredient batches from a corresponding storage bin to the mixing system is changed instantaneously or incrementally over time.

35. (canceled).

36. The method of claim 34, wherein the incremental or instantaneous change is initiated by a manual input or an automated input.

37. (canceled).

38. The method of claim 20, wherein the mixing system is continuously operating between delivery of the first mixture to the preconditioning system and delivery of the second mixture to the preconditioning system.

39. The method of claim 20, wherein the preconditioning system is continuously operating between delivery of the first preconditioned composition to the extrusion system and delivery of the second preconditioned composition to the extrusion system.

40. A system for the preparation of food compositions, the system comprising:
a preconditioning system;
a plurality of storage bins, each storage bin being independently coupled with the preconditioning system and configured to hold one or more food composition ingredients;
an extruder coupled with the precondition system; and
an extruder die.

41. The system of claim 40, further comprising a drying apparatus configured to receive an extruded composition from the extruder die.

42. (canceled).

43. The system of claim 40, further comprising a regulator between one of the plurality of storage bins and the preconditioning system, to regulate the amount of one or more food composition ingredients delivered from the storage bin to the preconditioning system.

44. The system of claim 43, wherein the regulator is controlled by a manual input or an automated input.

45. (canceled).
